(19) United States
(12) Patent Application Publication
(10) Pub. No.: US 2026/0349296 A1
(43) Pub. Date: Nov. 5, 2026

(54) DISPLAY APPARATUS HAVING REAR COVER WITH ASSEMBLY PORTION

(71) Applicant: SAMSUNG ELECTRONICS CO., LTD., Suwon-si (KR)

(72) Inventors: Yeonho KIM, Suwon-si (KR); Sunghwan PARK, Suwon-si (KR); Minho LEE, Suwon-si (KR); Jungwon MIN, Suwon-si (KR)

(73) Assignee: SAMSUNG ELECTRONICS CO., LTD., Suwon-si (KR)

(21) Appl. No.: 19/717,127

(22) Filed: Jun. 23, 2026

Related U.S. Application Data
(63) Continuation of application No. PCT/KR2026/003823, filed on Mar. 10, 2026.

(30) Foreign Application Priority Data
Apr. 2, 2025 (KR) 10-2025-0043152

(51) Int. Cl. G02F 1/1333

(52) U.S. Cl. CPC G02F 1/133314

(57) ABSTRACT

A display apparatus includes a display panel, a rear chassis on a rear side of the display panel and including a first assembly hole and a second assembly hole, and a rear cover on a rear surface of the rear chassis and including an assembly portion in the first assembly hole and the second assembly hole, where the assembly portion includes a hook in the first assembly hole and a retainer adjacent to the hook, in the second assembly hole, and configured to transmit, to the hook, a force generated by movement of the rear cover in response to the rear cover being assembled to the rear chassis.

### CROSS-REFERENCE TO RELATED APPLICATIONS

This application is a bypass continuation of International Application No. PCT/KR2026/003823, filed on Mar. 10, 2026, in the Korean Intellectual Property Receiving Office, which is based on and claims priority to Korean Patent Application No. 10-2025-0043152,filed on Apr. 2, 2025, in the Korean Intellectual Property Office, the disclosures of which are incorporated by reference herein in their entireties.

### BACKGROUND

### 1. Field

The disclosure relates to a display apparatus with an improved fastening method for coupling a rear cover to a rear chassis.

### 2. Description of Related Art

In general, a display apparatus is a device that displays a screen, and includes monitors and televisions. A display apparatus is a type of output device that converts acquired or stored electrical information into visual information and displays such information to a user, and is used in various fields such as homes and workplaces.

A display apparatus may include a monitor device connected to a personal computer (PC) or a server computer, a handheld computer device, a navigation terminal device, a conventional television device, an internet protocol television (IPTV) device, a portable terminal device such as a smartphone, tablet PC, personal digital assistants (PDA), or cellular phone, various display apparatuses used to play images such as advertisements or movies in industrial sites, or various other types of audio/video systems.

A display apparatus may include a display panel, a backlight unit that emits light to the display panel, a rear chassis to which the display panel and the backlight unit are fixed, and a rear cover fastened to a rear surface of the rear chassis.

Related art direct-fastening structures use a single, highly reinforced hook that depends solely on tension for assembly. However, when the available depth is extremely small (e.g., 5 mm), the hook cannot sufficiently retract due to its rigid reinforcement ribs, and the cover cannot move enough to accommodate the required overlap during assembly. As a result, the rear cover cannot be assembled, and excessive force can cause hook damage or assembly failure. Additionally, slim-design models require a fastening system that maintains strength while allowing repeated assembly and disassembly without breakage

Information disclosed in the Background Art section and the Technical Problem section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more embodiments provide a display apparatus in which a rear cover is fastened to a rear chassis in an improved fastening method.

One or more embodiments provide a display apparatus in which an assembly portion formed on a rear cover may be directly assembled to an assembly hole formed in a rear chassis.

One or more embodiments provide a display apparatus having a slim design while allowing an assembly portion formed on a rear cover to be directly assembled to an assembly hole formed in a rear chassis.

Additional aspects will be set forth in part in the description which follows and, in part, will be apparent from the description, or may be learned by practice of the presented embodiments.

According to an aspect of an example embodiment, a display apparatus may include a display panel, a rear chassis on a rear side of the display panel and including a first assembly hole and a second assembly hole, and a rear cover on a rear surface of the rear chassis and including an assembly portion in the first assembly hole and the second assembly hole, where the assembly portion includes a hook in the first assembly hole and a retainer adjacent to the hook, in the second assembly hole, and configured to transmit, to the hook, a force generated by movement of the rear cover in response to the rear cover being assembled to the rear chassis.

The assembly portion may include a connection rib connecting the hook and the retainer such that the hook and the retainer are aligned in a first direction, an anti-separation rib extending in a second direction perpendicular to the first direction and extending from the retainer along a front surface of the rear cover, and a reinforcing rib on the hook and configured to increase strength of the hook.

The hook may include a hook body connected to the connection rib such that the hook body and the connection rib are aligned in the first direction, where the reinforcing rib is on the hook body, and a hook head protruding from an upper portion of the hook body in the second direction, the hook head being in the first assembly hole.

The hook head may include a first portion adjacent to the retainer and protruding from the hook body by a first length, a second portion spaced apart from the first portion and protruding from the hook body by a second length that is shorter than the first length, and an inclined surface connecting the first portion and the second portion.

The hook head may include a first portion adjacent to the retainer and protruding from the hook body by a first length, a second portion spaced apart from the first portion and protruding from the hook body by a second length that is longer than the first length, and an inclined surface connecting the first portion and the second portion.

The hook head may include a first portion adjacent to the retainer and protruding from the hook body by a first length, a second portion spaced apart from the first portion and protruding from the hook body by a second length that is the same as the first length, and a connection surface connecting the first portion and the second portion.

The retainer may include a retainer body connected to the connection rib such that the retainer body and the connection rib are aligned in the first direction and a protrusion protruding from the retainer body and configured to be supported by the second assembly hole.

The retainer may be configured to protrude relative to the hook body by a length by which the protrusion protrudes from the retainer body.

The protrusion may be integral with the retainer body.

The protrusion may include a plurality of protruding ribs that are spaced apart from each other and protruding from the retainer body.

The hook and the retainer may be separate components.

The assembly portion may include an anti-separation rib extending in a first direction from the retainer along a front surface of the rear cover and a reinforcing rib on the hook and configured to increase strength of the hook.

The hook and the retainer may be aligned in a second direction that is perpendicular to the first direction.

The hook and the retainer may be offset in a second direction that is perpendicular to the first direction.

The hook and the retainer may be aligned in vertical direction with respect to the rear cover.

According to an aspect of an example embodiment, a display apparatus may include a display panel, a rear chassis on the display panel and including a first assembly hole and a second assembly hole, and a rear cover including an assembly portion, where the assembly portion includes a hook configured to be inserted in the first assembly hole, and a retainer adjacent to the hook, configured to be inserted in the second assembly hole, and configured to transmit, to the hook, a force generated by movement of the rear cover in response to the rear cover being assembled to the rear chassis.

The assembly portion may include a connection rib connecting the hook and the retainer such that the hook and the retainer are aligned in a first direction, an anti-separation rib extending in a second direction perpendicular to the first direction and extending from the retainer along a front surface of the rear cover, and a reinforcing rib on the hook and configured to increase strength of the hook.

The hook may include a hook body connected to the connection rib such that the hook body and the connection rib are aligned in the first direction, where the reinforcing rib is on the hook body, and a hook head protruding from an upper portion of the hook body in the second direction, the hook head being configured to be inserted in the first assembly hole.

According to an aspect of an example embodiment, an assembly portion may include a hook configured to be inserted in a first assembly hole of a chassis that is on a display panel, and a retainer adjacent to the hook and configured to be inserted in a second assembly hole of the chassis that is adjacent to the first assembly hole, and transmit, to the hook, a force generated by movement of a cover in response to the cover being assembled to the chassis.

The assembly portion may include a connection rib connecting the hook and the retainer, an anti-separation rib extending perpendicularly from the retainer and a reinforcing rib on the hook and configured to increase strength of the hook.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is an exploded perspective view of a display apparatus according to an embodiment;

FIG. 2 is a view illustrating a state in which a rear cover is assembled to a rear surface of a rear chassis according to an embodiment;

FIG. 3 is an enlarged view illustrating a state in which an assembly portion formed on a front surface of a rear cover is assembled to a first assembly hole and a second assembly hole formed in a rear chassis, according to an embodiment;

FIG. 4 is a view illustrating a state in which an assembly portion of a rear cover is being inserted in a first assembly hole and a second assembly hole of a rear chassis according to an embodiment;

FIG. 5 is a plan view illustrating an assembly portion according to an embodiment;

FIG. 6 is a perspective view illustrating a state in which an assembly portion of a rear cover is inserted in a first assembly hole and a second assembly hole of a rear chassis according to an embodiment;

FIG. 7 is a view illustrating a state in which an assembly portion of a rear cover is inserted in a first assembly hole and a second assembly hole of a rear chassis, viewed from a front surface of the rear chassis, according to an embodiment;

FIG. 8 is a view illustrating a cross-section taken along line A-A of FIG. 7;

FIG. 9 is a view illustrating a cross-section taken along line B-B of FIG. 7;

FIG. 10 is a view illustrating an operation of assembling a rear cover to a rear chassis, according to an embodiment;

FIG. 11 is a view illustrating a state in which a hook body and a retainer body are provided to have the same height, according to an embodiment;

FIG. 12 is a view illustrating a state in which an assembly portion including a hook head having a different shape from a hook head formed on the rear cover shown in FIG. 4 is inserted in a first assembly hole and a second assembly hole of a rear chassis;

FIG. 13 is a view illustrating a state in which the assembly portion shown in FIG. 12 is inserted in a first assembly hole and a second assembly hole of a rear chassis, viewed from a front surface of the rear chassis;

FIG. 14 is a view illustrating a state in which an assembly portion including a hook head having a different shape from a hook head formed on the rear cover shown in FIG. 4 is inserted in a first assembly hole and a second assembly hole of a rear chassis;

FIG. 15 is a view illustrating a state in which the assembly portion shown in FIG. 14 is inserted in a first assembly hole and a second assembly hole of a rear chassis, viewed from a front surface of the rear chassis;

FIG. 16 is a view illustrating a state in which an assembly portion including a protrusion having a different shape from a protrusion of a retainer formed on the rear cover shown in FIG. 4 is inserted in a first assembly hole and a second assembly hole of a rear chassis;

FIG. 17 is a view illustrating a state in which the assembly portion shown in FIG. 16 is inserted in a first assembly hole and a second assembly hole of a rear chassis, viewed from a front surface of the rear chassis;

FIG. 18 is a view illustrating a state in which a hook and a retainer formed on a rear cover are provided separately, according to an embodiment;

FIG. 19 is a view illustrating a state in which the assembly portion shown in FIG. 18 is inserted in a first assembly hole and a second assembly hole of a rear chassis, viewed from a front surface of the rear chassis;

FIG. 20 is a view illustrating a state in which a hook and a retainer formed on a rear cover are provided to be offset from the same line in a left-right direction of the rear cover according to an embodiment;

FIG. 21 is a view illustrating a state in which the assembly portion shown in FIG. 20 is inserted in a first assembly hole and a second assembly hole of a rear chassis, viewed from a front surface of the rear chassis;

FIG. 22 is a view illustrating a state in which a hook and a retainer formed on a rear cover are provided on the same line in a vertical direction of the rear cover according to an embodiment; and

FIG. 23 is a view illustrating a state in which the assembly portion shown in FIG. 22 is inserted in a first assembly hole and a second assembly hole of a rear chassis, viewed from a front surface of the rear chassis.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Terms such as first, second, etc. may be used to describe various components, but are used only for the purpose of distinguishing one component from another component. These terms do not limit the difference in the material or structure of the components.

The term of “and/or” includes a plurality of combinations of relevant items or any one item among a plurality of relevant items.

The terms of a singular form may include plural forms unless otherwise specified. In addition, when a certain part “includes” a certain component, it means that other components may be further included rather than excluding other components unless otherwise stated.

In addition, in the present disclosure, the meaning of “identical” or “the same” and variations thereof includes cases where properties are similar to each other or similar within a certain range. Furthermore, identical means “substantially identical”. The meaning of substantially identical should be understood to include numerical values within manufacturing error ranges or differences within a range that is insignificant with respect to a reference numerical value as falling within the scope of ‘identical’.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

In addition, terms such as “part”, “portion”, “unit”, “block”, “member”, “module”, and the like, may refer to a unit that processes at least one function or operation. For example, these terms may refer to at least one hardware such as a field-programmable gate array (FPGA)/application specific integrated circuit (ASIC), at least one software stored in memory, or at least one process processed by a processor.

Terms used in the following description such as “front”, “rear”, “left”, and “right”, and the like, are defined based on the drawings, and the shape and position of each element are not limited by these terms.

Hereinafter, various embodiments of the disclosure will be described in detail with reference to the accompanying drawings.

As used herein, “assembled” and its variations (e.g., “assembled in”) may refer to components being connected to or inserted into other components to achieve assembly of the overall device, as will be understood by the context of the use of such a term herein. In particular, a first component being “assembled in” a second component is not intended to indicate that the first component is constructed or manufactured in the second component. “Assembled in/to/etc.” may refer to components being connected to, inserted to, etc., other components.

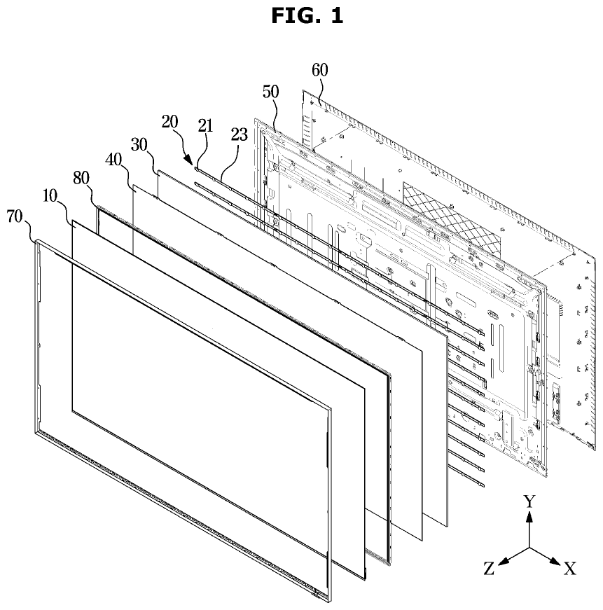

FIG. 1 is an exploded perspective view of a display apparatus according to an embodiment.

An X direction shown in the drawings may be a horizontal direction. A Y direction shown in the drawings may be a vertical direction. A Z direction shown in the drawings may be a direction perpendicular to the X and Y direction.

As shown in FIG. 1, a display apparatus may include a display panel 10 on which an image is displayed. The display apparatus may include a light source module 20 disposed on a rear side of the display panel 10 to emit light to the display panel 10. The display apparatus may include a light guide plate 30 disposed on the rear side of the display panel 10 to guide light emitted from the light source module 20 to the display panel 10. The display apparatus may include an optical sheet 40 disposed between the display panel 10 and the light guide plate 30 to improve optical characteristics of light guided to the display panel 10 by the light guide plate 30. The display apparatus may include a rear chassis 50 disposed on the rear side of the display panel 10 and on which the light source module 20 is seated. The display apparatus may include a rear cover 60 coupled to a rear surface of the rear chassis 50 to form a rear appearance of the display apparatus.

A reflective sheet that reflects light emitted through a rear surface of the light guide plate 30 to the front may be disposed at the rear of the light guide plate 30.

The display panel 10 may be configured as a liquid crystal display panel using liquid crystals, and may include a thin film transistor (TFT) substrate on which thin film transistors are formed, a color filter (CF) substrate facing the TFT substrate, and a liquid crystal provided between the TFT substrate and the CF substrate.

The TFT substrate may be a transparent glass substrate on which the TFTs, which are switching elements, are formed in a matrix form.

Data lines may be connected to source terminals of the TFTs, gate lines may be connected to gate terminals, and pixel electrodes made of a transparent conductive material may be connected to drain terminals.

The CF substrate may be disposed opposite the TFT substrate with a certain gap, and may be a substrate on which red, green, blue (RGB) pixels, which are color pixels that are expressed as a predetermined color when light passes through, are formed by a thin film process. A common electrode made of a transparent conductive material may be formed on a front surface of the CF substrate.

In the display panel 10 having the configurations described above, an electric field may be formed the pixel electrode and the common electrode when power is applied to the gate terminal of the TFT, and the electric field may change an arrangement of liquid crystals interposed between the TFT substrate and the CF substrate.

The display panel 10 may form an image by adjusting the arrangement of liquid crystals, but since it is not able to emit light by itself, it may display the image by receiving light from the light source module 20 located at the rear of the display panel 10.

A drive printed circuit board that supplies a drive signal to the display panel 10 may be disposed below the display panel 10, and the display panel 10 and the drive printed circuit board may be electrically connected by a plurality of flexible circuit films on one side of which a drive chip is mounted.

The light source module 20 may be disposed on the rear side of the display panel 10, which is not able to emit light by itself, to supply light to the display panel 10. The light source module 20 may include a plurality of light sources 21 that emit light to the display panel 10. The plurality of light sources 21 may be provided as a plurality of light emitting diodes (LEDs).

The light source module 20 may include a printed circuit board 23 on which the plurality of light sources 21 are mounted. The printed circuit board 23 may have a conductive pattern thereon. The printed circuit board 23 may be provided in a plurality. The plurality of printed circuit boards 23 may be seated on a front surface of the rear chassis 50.

The light source module 20 may be disposed on the rear side of the light guide plate 30 with a certain gap to emit light onto the light guide plate 30, and the light emitted to the light guide plate 30 may be redirected by the light guide plate 30 and delivered to the display panel 10.

The light guide plate 30 may disposed on the rear side of the display panel 10 and may guide light emitted from the plurality of light sources 21 to the display panel 10. The light guide plate 30 may be seated on the rear chassis 50.

Although the drawings show a direct-type display method in which the light source module 20 is disposed on the rear side of the light guide plate 30 and emits light onto the light guide plate 30, the present disclosure is not limited thereto. It should be appreciated that the present disclosure may also be applied to an edge-type display method in which the light source module 20 is disposed with a predetermined gap from a lower end portion of the light guide plate 30 and emits light onto the lower end portion of the light guide plate 30.

The optical sheet 40 may be disposed between the display panel 10 and the light guide plate 30 to improve optical characteristics of light guided to the display panel 10 by the light guide plate 30, and may include a diffusion sheet that diffuses the light guided through the light guide plate 30 to improve luminance uniformity, a light condensing sheet that aligns a direction of light so that the light diffused by the diffusion sheet is incident perpendicular to the display panel 10, and a protective sheet that protects the light condensing sheet.

The rear chassis 50 may be disposed on the rear side of the display panel 10. The light source module 20 may be seated on the front surface of the rear chassis 50. The light guide plate 30 may be seated on the front surface of the rear chassis 50. The rear cover 60 may be coupled to the rear surface of the rear chassis 50. The rear chassis 50 may include a plurality of first assembly holes 51 and a plurality of second assembly holes 53 to which the rear cover 60 is assembled/attached. A detailed description of the configuration in which the rear cover 60 is coupled to the rear surface of the rear chassis 50 will be described later.

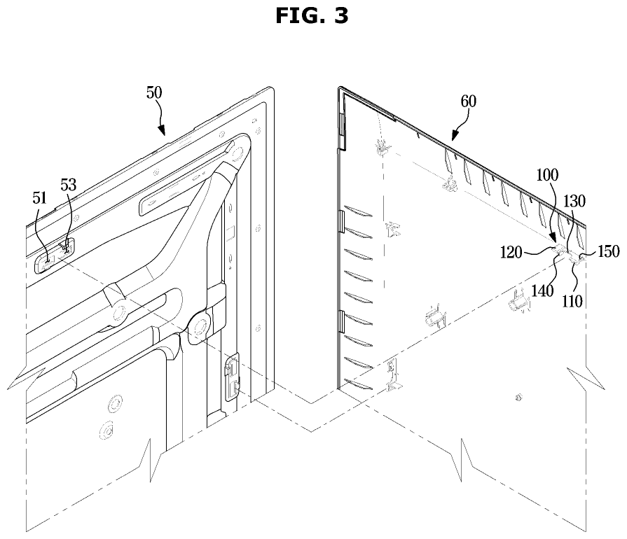

The rear cover 60 may be coupled to the rear surface of the rear chassis 50 to form a rear appearance of the display apparatus. The rear cover 60 may include a plurality of assembly portions 100 (FIG. 3) coupled to the rear surface of the rear chassis 50. A detailed description of the configuration in which the rear cover 60 is coupled to the rear surface of the rear chassis 50 will be described later.

The display apparatus may include a bezel 70 that surrounds a border of the display panel 10, and a middle mold 80 to which the display panel 10 is secured. The bezel 70 may be configured to surround the border of the display panel 10 to form a rectangular frame of the display apparatus.

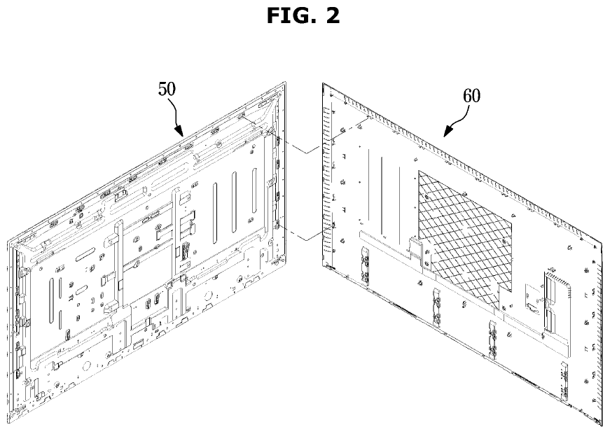

FIG. 2 is a view illustrating a state in which a rear cover is assembled to a rear surface of a rear chassis according to an embodiment. FIG. 3 is an enlarged view illustrating a state in which an assembly portion formed on a front surface of a rear cover is assembled in a first assembly hole and a second assembly hole formed in a rear chassis, according to an embodiment.

As shown in FIGS. 2 and 3, the rear cover 60 may be assembled to the rear surface of the rear chassis 50. To assemble the rear cover 60 to the rear surface of the rear chassis 50, the rear cover 60 may include an assembly portion 100 provided on the front surface of the rear cover 60. The assembly portion 100 may be provided in a plurality.

To assemble the rear cover 60 to the rear surface of the rear chassis 50, the rear chassis 50 may include a first assembly hole 51 and a second assembly hole 53. The assembly portion 100 of the rear cover 60 may be inserted in the first assembly hole 51 and the second assembly hole 53. The plurality of first assembly holes 51 and the plurality of second assembly holes 53 may be provided. The first assembly hole 51 and the second assembly hole 53 may be provided adjacent to each other. A single assembly portion 100 may be inserted in the first assembly hole 51 and the second assembly hole 53 that are adjacent to each other. The first assembly hole 51 and the second assembly hole 53 in which the assembly portion 100 is assembled may be provided in a plurality to correspond to a plurality of assembly portions 100.

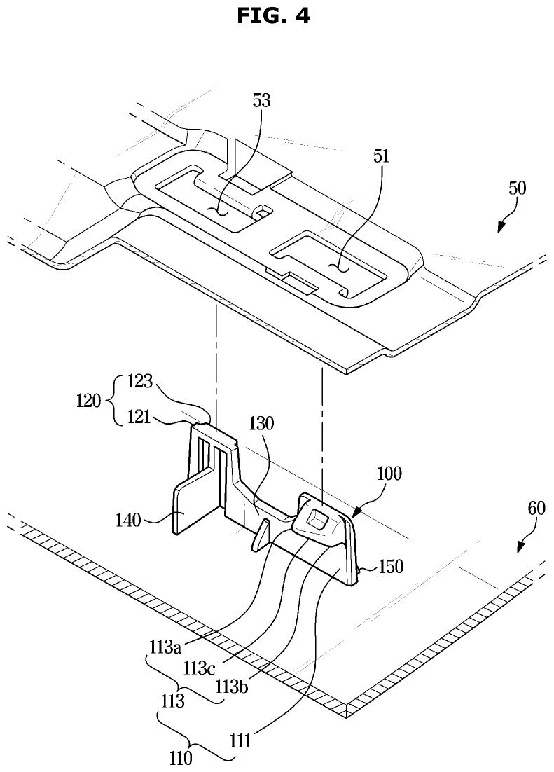

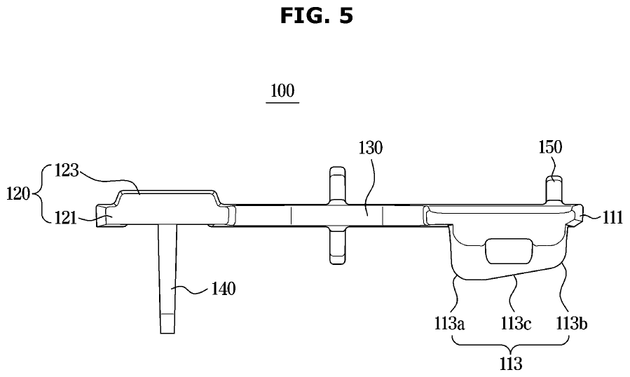

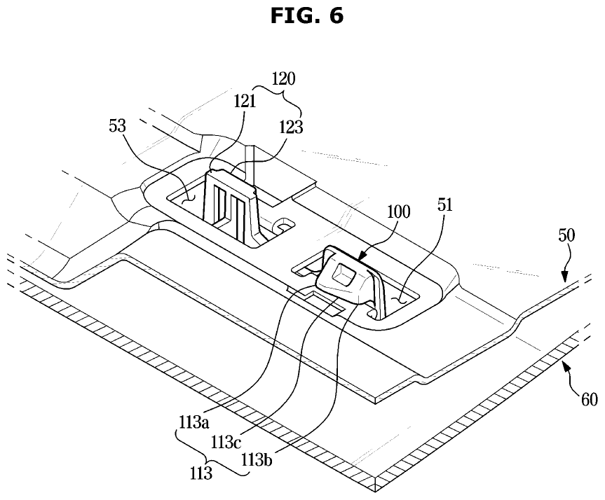

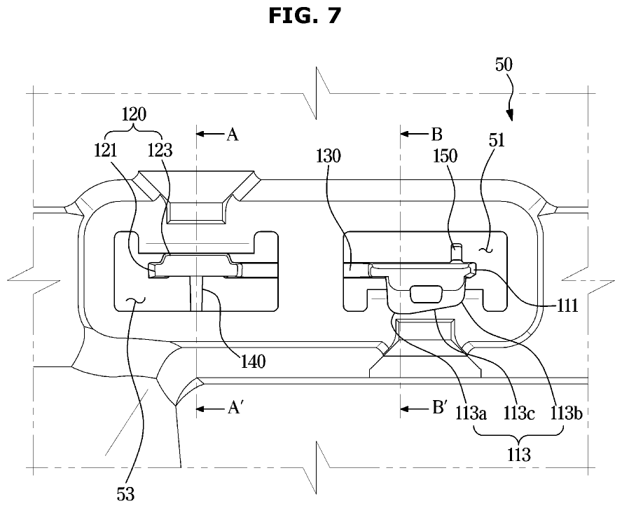

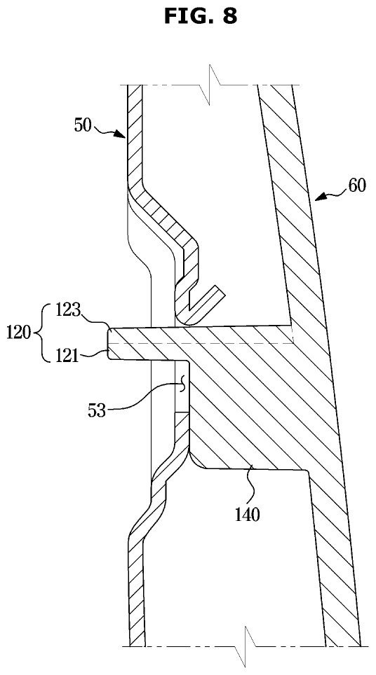

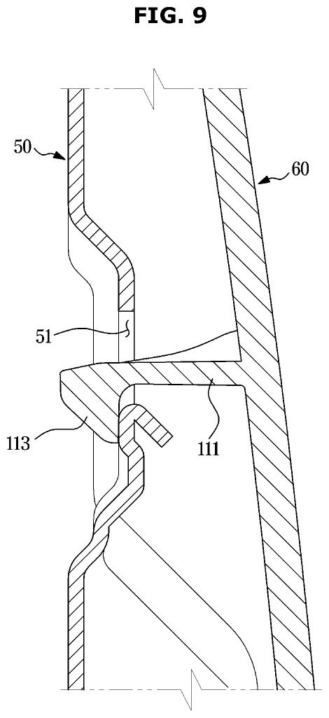

FIG. 4 is a view illustrating a state in which an assembly portion of a rear cover is being inserted in a first assembly hole and a second assembly hole of a rear chassis according to an embodiment. FIG. 5 is a plan view illustrating an assembly portion according to an embodiment. FIG. 6 is a perspective view illustrating a state in which an assembly portion of a rear cover is inserted in a first assembly hole and a second assembly hole of a rear chassis according to an embodiment. FIG. 7 is a view illustrating a state in which an assembly portion of a rear cover is inserted in a first assembly hole and a second assembly hole of a rear chassis, viewed from a front surface of the rear chassis, according to an embodiment. FIG. 8 is a view illustrating a cross-section taken along line A-A of FIG. 7. FIG. 9 is a view illustrating a cross-section taken along line B-B of FIG. 7.

As shown in FIGS. 4 to 9, the rear chassis 50 may include the first assembly hole 51 and the second assembly hole 53 for assembling the rear cover 60 to the rear surface of the rear chassis 50. The assembly portion 100 of the rear cover 60 may be inserted in the first assembly hole 51 and the second assembly hole 53. The first assembly hole 51 and the second assembly hole 53 may be provided adjacent to each other in a horizontal direction of the rear chassis 50. The first assembly hole 51 and the second assembly hole 53 may be provided to be flush with the rear chassis 50 in the horizontal direction.

The rear cover 60 may include the assembly portion 100 that is inserted in the rear chassis 50. The assembly portions 100 may be provided in a plurality. The assembly portion 100 may each include a hook 110 and a retainer 120. The hook 110 and the retainer 120 may constitute a single assembly portion 100. The hook 110 and the retainer 120 may be provided at adjacent positions in the horizontal direction of the rear cover 60.

The assembly portion 100 may include the hook 110. The hook 110 may be inserted in the rear chassis 50. The hook 110 may be inserted in the first assembly hole 51 formed in the rear chassis 50.

To achieve a slim configuration of the display apparatus, it may be necessary to minimize a gap between the rear chassis 50 and the rear cover 60 assembled to the rear chassis 50. For example, when the rear chassis 50 and the rear cover 60 are assembled, the gap between the rear chassis 50 and the rear cover 60 may be 5 mm. Since the gap between the rear chassis 50 and the rear cover 60 is 5 mm, a space between the rear chassis 50 and the rear cover 60 may be narrow. Since the space between the rear chassis 50 and the rear cover 60 is narrow, the hook 110 may require a large amount of tension when assembling the rear cover 60 to the rear chassis 50.

The hook 110 may include a hook body 111. The hook body 111 may be formed to protrude from the front surface of the rear cover 60. The hook body 111 may be formed to protrude perpendicularly from the front surface of the rear cover 60. The front surface of the rear cover 60 may be a surface facing the rear chassis 50 when the rear cover 60 is assembled to the rear chassis 50. The hook body 111 may be configured to have a thin thickness to have a large tension. To reinforce strength of the hook body 111 having a thin thickness, a reinforcing rib 150, which will be described later, may be formed on the hook body 111.

The hook 110 may include a hook head 113. The hook head 113 may be formed to protrude from an upper portion of the hook body 111. The hook head 113 may be formed to protrude from the hook body 111. A direction in which the hook head 113 protrudes from the hook body 111 may be the same as a direction in which an anti-separation rib 140, which extends perpendicularly from the retainer 120 to be described later, extends from the retainer 120. The hook head 113 may be inserted in the first assembly hole 51.

The hook head 113 may include a first portion 113a. The first portion 113a may be formed at a position adjacent to the retainer 120. That is, the first portion 113a may be nearest to the retainer 120 in the horizontal direction versus the other portions 113b and 113c. The first portion 113a may be formed to protrude from the hook body 111 at a position adjacent to the retainer 120.

The hook head 113 may include a second portion 113b. The second portion 113b may be spaced apart from the first portion 113a with the third portion 113c therebetween. The second portion 113b may be formed at a position relatively farther from the retainer 120 than the first portion 113a. The second portion 113b may be formed to protrude from the hook body 111 at a position relatively farther from the retainer 120 than the first portion 113a. The second portion 113b may be formed to protrude from the hook body 111 a shorter distance than the first portion 113a. The first portion 113a may be formed to protrude from the hook body 111 longer than the second portion 113b.

The hook head 113 may include an inclined surface 113c (e.g., a third portion between the first portion 113a and the second portion 113b). The inclined surface 113c may be a surface connecting the first portion 113a and the second portion 113b. The inclined surface 113c may be a surface connecting the first portion 113a and the second portion 113b in an inclined manner.

The assembly portion 100 may include the retainer 120. The retainer 120 may be inserted in the rear chassis 50. The retainer 120 may be inserted in the second assembly hole 53 formed in the rear chassis 50. The retainer 120 may be provided adjacent to the hook 110 in the horizontal direction of the rear cover 60.

The retainer 120 may include a retainer body 121. The retainer body 121 may be formed to protrude from the front surface of the rear cover 60. The retainer body 121 may be formed to protrude vertically from the front surface of the rear cover 60. The retainer body 121 may be formed to be aligned with the hook body 111 in the horizontal direction of the rear cover 60. The hook body 111 and the retainer body 121, which are positioned on the same line in the horizontal direction of the rear cover 60 may be connected by a connection rib 130, which will be described later.

The retainer body 121 may be provided to have a height higher than the hook body 111. The retainer body 121 may be formed to protrude higher from the front surface of the rear cover 60 than the hook body 111. The hook body 111 may be formed to protrude from the front surface of the rear cover 60 to have a height of at least 7.8 mm. The hook body 111 may have a height of at least 7.8 mm, but may not be limited to a maximum height.

Because the retainer body 121 is formed to protrude higher from the front surface of the rear cover 60 than the hook body 111, the retainer body 121 may act as a guide when the rear cover 60 is assembled to the rear chassis 50. For example, when the rear cover 60 is assembled to the rear chassis 50, the retainer body 121 may be inserted in the second assembly hole 53 before the hook 110 and may guide a position of the hook 110 so that the position of the hook 110 corresponds to a position of the first assembly hole 51. Since the position of the hook 110 is guided by the retainer body 121 so that the position of the hook 110 corresponds to the position of the first assembly hole 51, damage to the hook 110 due to incorrect assembly of the hook 110 may be prevented.

The retainer 120 may include a protrusion 123. The protrusion 123 may be formed to protrude from the retainer body 121. When the retainer 120 is inserted in the second assembly hole 53, the protrusion 123 may be supported on one side of the second assembly hole 53. The retainer 120 may be configured to protrude farther than the hook body 111 by a length by which the protrusion 123 protrudes from the retainer body 121. Because the retainer body 121 and the hook body 111 are positioned on the same line in the horizontal direction of the rear cover 60, the retainer 120 may be provided to protrude from the hook body 111 by a length such that the protrusion 123 protrudes from the retainer body 121.

The protrusion 123 may protrude from the retainer body 121 by a gap between the first assembly hole 51 and the hook body 111 when the hook head 113 is inserted in the first assembly hole 51. Since the protrusion 123 protrudes from the retainer body 121 by the gap between the first assembly hole 51 and the hook body 111 when the hook head 113 is inserted in the first assembly hole 51, the protrusion 123 may be supported on one side of the second assembly hole 53 when the hook head 113 is inserted in the first assembly hole 51.

The protrusion 123 may be provided as an integral protrusion protruding integrally from the retainer body 121 (i.e., the protrusion 123 may be integral with the retainer body 121).

The assembly portion 100 may include the connection rib 130. The connection rib 130 may connect the hook 110 and the retainer 120 such that the hook 110 and the retainer 120 are aligned in the horizontal direction of the rear cover 60. The connection rib 130 may connect the hook body 111 and the retainer body 121 such that they are positioned on the same line in the horizontal direction of the rear cover 60.

The assembly portion 100 may include the anti-separation rib 140. The anti-separation rib 140 may extend perpendicularly from the retainer 120. The anti-separation rib 140 may extend perpendicularly from the retainer 120 along the front surface of the rear cover 60. The anti-separation rib 140 may extend perpendicularly from the retainer body 121 of the retainer 120 along the front surface of the rear cover 60. The anti-separation rib 140 may extend from the retainer body 121 in the same direction as a direction in which the hook head 113 protrudes from the hook body 111.

The anti-separation rib 140 may be positioned on the rear surface of the rear chassis 50 when the hook 110 and the retainer 120 are inserted in the first assembly hole 51 and the second assembly hole 53, respectively. For example, when the hook 110 and the retainer 120 are inserted in the first assembly hole 51 and the second assembly hole 53, respectively, the hook 110 may be positioned on the front surface of the rear chassis 50, and the anti-separation rib 140 may be positioned on the rear surface of the rear chassis 50. The anti-separation rib 140 may be positioned on a side opposite the hook 110 relative to the rear chassis 50, thereby preventing disengagement of the hook 110 inserted in the first assembly hole 51. The anti-separation rib 140 may restrict rotation of the rear cover 60 in the direction of disengagement of the hook 110, thereby increasing a removal force when disassembling the hook 110 from the first assembly hole 51.

The assembly portion 100 may include the reinforcing rib 150. The reinforcing rib 150 may be formed on the hook body 111. The reinforcing rib 150 may be formed on an opposite side of the hook head 113 protruding from the hook body 111. For example, the hook head 113 may be formed to protrude from one surface of the hook body 111, and the reinforcing rib 150 may be formed on the other surface of the hook body 111. The reinforcing rib 150 may add to the strength of the hook 11, which, as described above, is provided to have a small thickness for large tension. The reinforcing rib 150 may reinforce the strength of the hook body 111, which is provided to have a thin thickness for large tension.

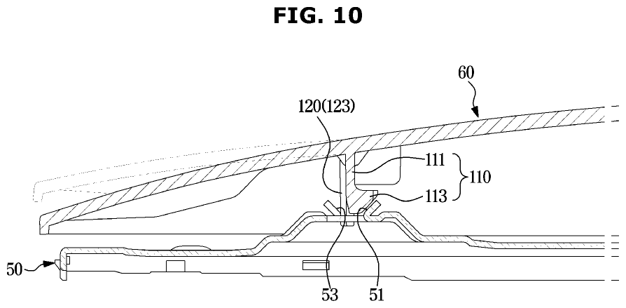

FIG. 10 is a view illustrating an operation of assembling a rear cover to a rear chassis, according to an embodiment.

As shown in FIG. 10, the rear cover 60 may be assembled to the rear chassis 50. The assembly portion 100 of the rear cover 60 may be inserted in the first assembly hole 51 and the second assembly hole 53 of the rear chassis 50. The hook 110 and the retainer 120 of the assembly portion 100 may be inserted in the first assembly hole 51 and the second assembly hole 53 of the rear chassis 50, respectively.

When assembling the rear cover 60 to the rear chassis 50, the rear cover 60 may be assembled to the rear chassis 50 in a tilted state. The rear cover 60 may be assembled to the rear chassis 50 such that the hook head 113 is tilted in a downward direction, opposite to the direction in which the hook body 111 is protruding relative to the hook head 113. When assembling the rear cover 60 to the rear chassis 50 with the rear cover 60 tilted, the rear cover 60 may be rotated to be horizontal once a portion of the retainer 120 is inserted in the second assembly hole 53. When rotating the rear cover 60 to be horizontal, a force generated by the rotation of the rear cover 60 may be transmitted to the hook 110 because the retainer 120 is supported by the second assembly hole 53. Because the force generated by rotation of the rear cover 60 is transmitted to the hook 110, the hook 110 may be more easily inserted into the first assembly hole 51 with only a small force. As described above, the retainer 120 may ensure that when the rear cover 60 is inserted in the rear chassis 50, the force generated by movement of rotating the rear cover 60 is transmitted to the hook 110.

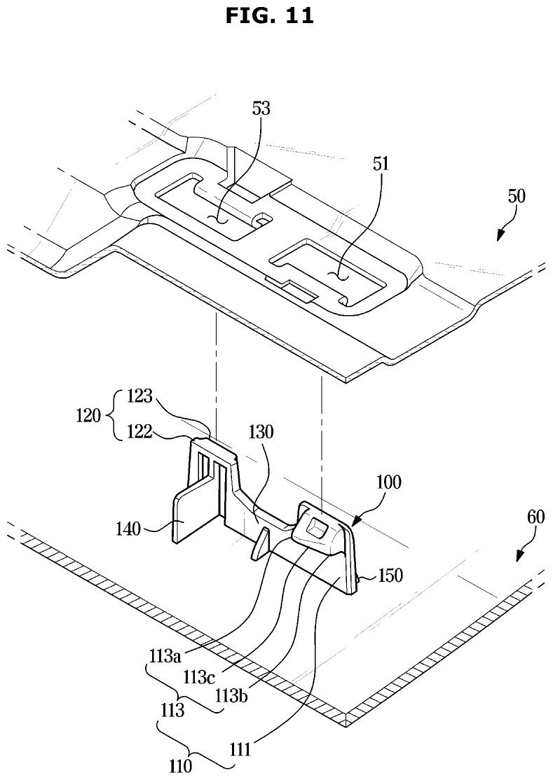

FIG. 11 is a view illustrating a state in which a hook body and a retainer body are provided to have the same height, according to an embodiment.

As shown in FIG. 11, a height at which the hook body 111 protrudes from the rear cover 60 may be the same as a height at which the retainer body 122 protrudes from the rear cover 60. Since the hook body 111 has a height of at least 7.8 mm and is not limited to a maximum height, the retainer body 122 may have a height corresponding to the height of the hook body 111.

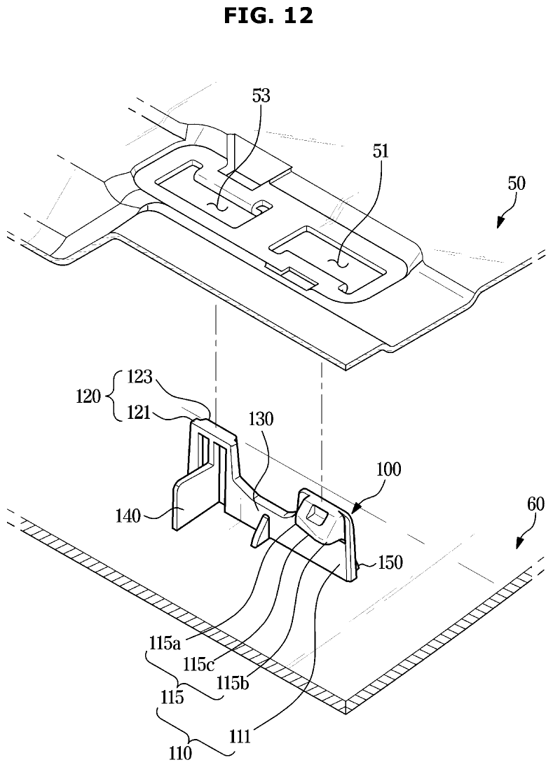

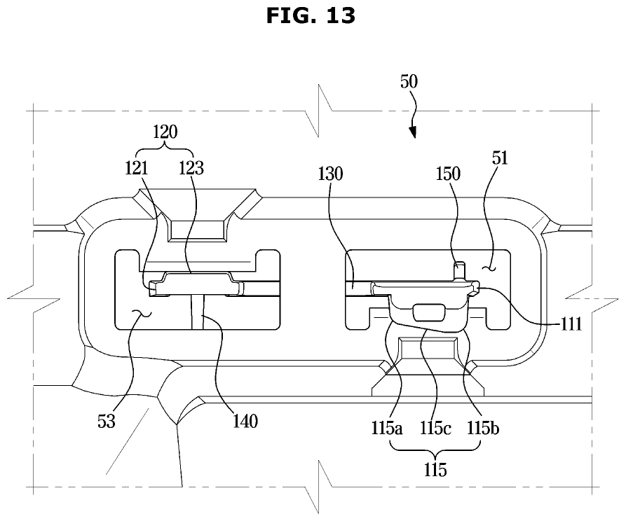

FIG. 12 is a view illustrating a state in which an assembly portion including a hook head having a different shape from a hook head formed on the rear cover shown in FIG. 4 is inserted in a first assembly hole and a second assembly hole of a rear chassis. FIG. 13 is a view illustrating a state in which the assembly portion shown in FIG. 12 is inserted in a first assembly hole and a second assembly hole of a rear chassis, viewed from a front surface of the rear chassis.

As shown in FIGS. 12 and 13, the rear chassis 50 may include the first assembly hole 51 and the second assembly hole 53 to which the rear cover 60 is assembled. The rear cover 60 may include the assembly portion 100 inserted in the first assembly hole 51 and the second assembly hole 53. The assembly portion 100 may include the hook 110 inserted in the first assembly hole 51. The assembly portion 100 may include the retainer 120 inserted in the second assembly hole 53. Other than the configuration of the hook 110, the remaining configurations may be the same as the configurations shown in FIGS. 4 to 9. Of the configurations of the hook 110, the remaining configurations other than the configuration of a hook head 115 may be the same as the configurations shown in FIGS. 4 to 9. Only the configuration of the hook head 115, which is different from the configuration shown in FIGS. 4 to 9, will be described.

The hook 110 may include a hook head 115. The hook head 115 may be formed to protrude from an upper portion of the hook body 111. The hook head 115 may be formed to protrude from the hook body 111. A direction in which the hook head 115 protrudes from the hook body 111 may be the same as a direction in which the anti-separation rib 140 extending perpendicularly from the retainer 120 extends from the retainer 120. The hook head 115 may be inserted in the first assembly hole 51.

The hook head 115 may include a first portion 115a. The first portion 115a may be formed at a position adjacent to the retainer 120. The first portion 115a may be formed to protrude from the hook body 111 at a position adjacent to the retainer 120.

The hook head 115 may include a second portion 115b. The second portion 115b may be spaced apart from the first portion 115a with the third portion 115c therebetween. The second portion 115b may be formed at a position relatively farther from the retainer 120 than the first portion 115a. The second portion 115b may be formed to protrude from the hook body 111 at a position relatively farther from the retainer 120 than the first portion 115a. The second portion 115b may be formed to protrude from the hook body 111 by a greater distance than the first portion 115a. The first portion 115a may be formed to protrude by a lesser distance from the hook body 111 than the second portion 115b.

The hook head 115 may include an inclined surface 115c. The inclined surface 115c may be a surface connecting the first portion 115a and the second portion 115b. The inclined surface 115c may be a surface connecting the first portion 115a and the second portion 115b in an inclined manner.

The hook head 115 may have different lengths of the first portion 115a and the second portion 115b and different inclination direction of the inclined surface 115c compared to the hook head 113 shown in FIGS. 4 to 9. The hook head 115 may have improved ability to assemble (e.g., ease and reliability of assembly), but may have poorer release force compared to the hook head 113. For example, the hook head 115 may be easier to assemble into the first assembly hole 51 compared to the hook head 113, but may require a greater force to remove from the first assembly hole 51.

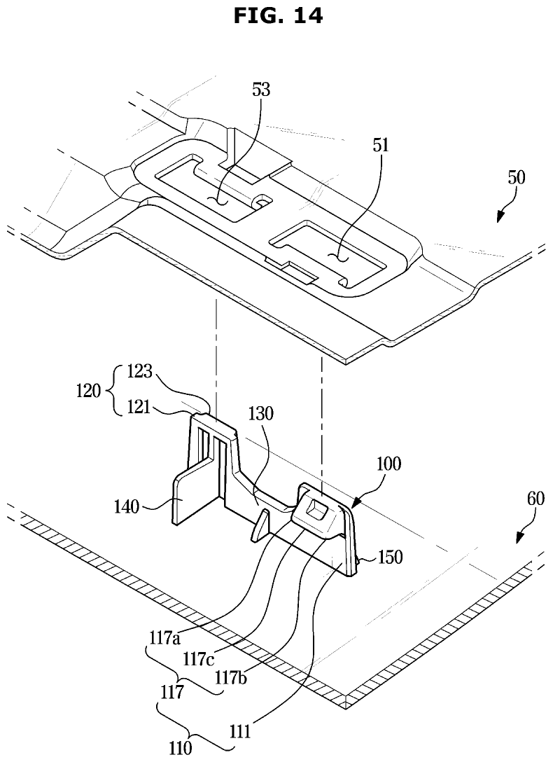

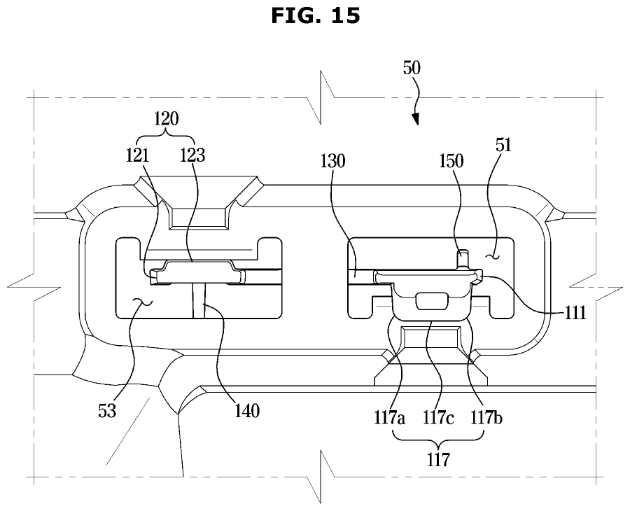

FIG. 14 is a view illustrating a state in which an assembly portion including a hook head having a different shape from a hook head formed on the rear cover shown in FIG. 4 is inserted in a first assembly hole and a second assembly hole of a rear chassis. FIG. 15 is a view illustrating a state in which the assembly portion shown in FIG. 14 is inserted in a first assembly hole and a second assembly hole of a rear chassis, viewed from a front surface of the rear chassis.

As shown in FIGS. 14 and 15, the rear chassis 50 may include the first assembly hole 51 and the second assembly hole 53 to which the rear cover 60 is assembled. The rear cover 60 may include the assembly portion 100 inserted in the first assembly hole 51 and the second assembly hole 53. The assembly portion 100 may include the hook 110 inserted in the first assembly hole 51. The assembly portion 100 may include the retainer 120 inserted in the second assembly hole 53. Other than the configuration of the hook 110, the remaining configurations may be the same as the configurations shown in FIGS. 4 to 9. Of the configurations of the hook 110, the remaining configurations other than the configuration of a hook head 117 may be the same as the configurations shown in FIGS. 4 to 9. Only the configuration of the hook head 117, which is different from the configurations shown in FIGS. 4 to 9 will be described.

The hook 110 may include a hook head 117. The hook head 117 may be formed to protrude from an upper portion of the hook body 111. The hook head 117 may be formed to protrude from the hook body 111. A direction in which the hook head 117 protrudes from the hook body 111 may be the same as a direction in which the anti-separation rib 140 extending perpendicularly from the retainer 120 extends from the retainer 120. The hook head 117 may be inserted in the first assembly hole 51.

The hook head 117 may include a first portion 117a. The first portion 117a may be formed at a position adjacent to the retainer 120 (i.e., closer to the retainer 120 than the other portions 117ba and 117c). The first portion 117a may be formed to protrude from the hook body 111 at a position adjacent to the retainer 120.

The hook head 117 may include a second portion 117b. The second portion 117b may be spaced apart from the first portion 117a with the third portion 117c therebetween. The second portion 117b may be formed at a position relatively farther from the retainer 120 than the first portion 117a. The second portion 117b may be formed to protrude from the hook body 111 at a position relatively farther from the retainer 120 than the first portion 117a. The first portion 117a and the second portion 117b may be formed to protrude from the hook body 111 to have the same length.

The hook head 117 may include a connection surface 117c. The connection surface 117c may be a surface connecting the first portion 117a and the second portion 117b. The connection surface 117c connecting the first portion 117a and the second portion 117b may have no inclination with respect to the first portion 117a and the second portion 117b in at least one direction.

The hook head 117 may have the same length of the first portion 117a and the second portion 117b and no inclination of the connection surface 117c connecting the first portion 117a and the second portion 117b, compared to the hook head 113 shown in FIGS. 4 to 9 and the hook head 115 shown in FIGS. 12 to 13. Assemblability (e.g., ease and reliability of assembly) of the hook head 117 may be improved compared to the hook head 113, but may be worse than the hook head 115. The release force of the hook head 117 may be worse than the hook head 113, but may be improved compared to the hook head 115. For example, the hook head 117 may be easier to assemble into the first assembly hole 51 compared to the hook head 113, but may be more difficult to assemble into the first assembly hole 51 compared to the hook head 115. In addition, the hook head 117 may require a greater force to remove from the first assembly hole 51 compared to the hook head 113, but may require a smaller force to remove from the first assembly hole 51 compared to the hook head 115.

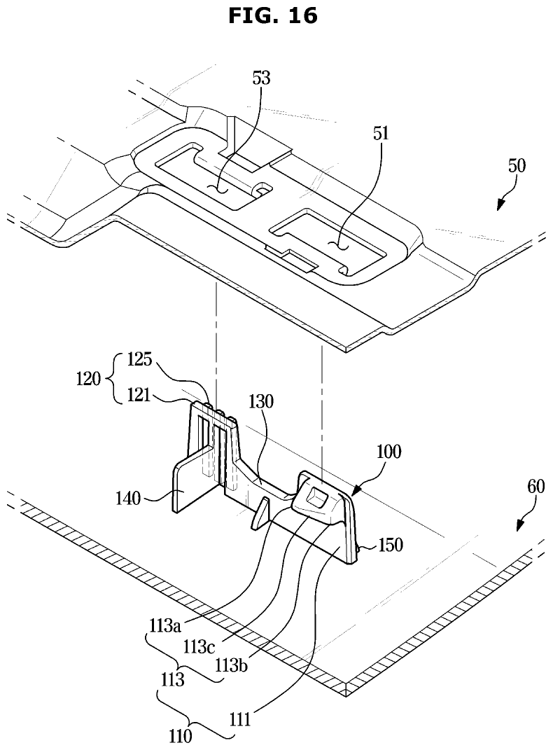

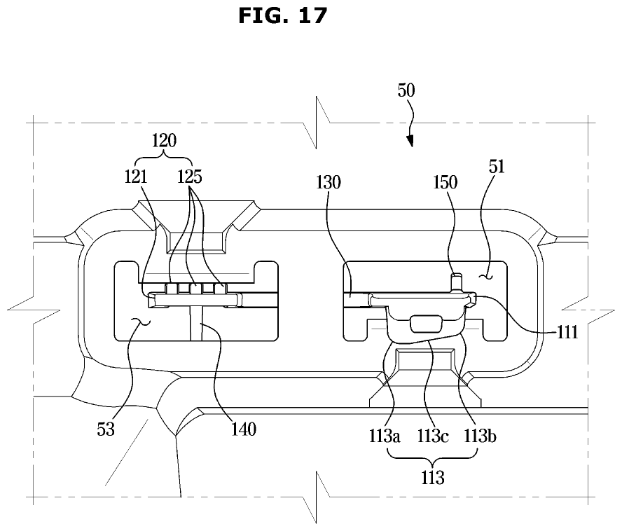

FIG. 16 is a view illustrating a state in which an assembly portion including a protrusion having a different shape from a protrusion of a retainer formed on the rear cover shown in FIG. 4 is inserted in a first assembly hole and a second assembly hole of a rear chassis. FIG. 17 is a view illustrating a state in which the assembly portion shown in FIG. 16 is inserted in a first assembly hole and a second assembly hole of a rear chassis, viewed from a front surface of the rear chassis.

As shown in FIGS. 16 and 17, the rear chassis 50 may include the first assembly hole 51 and the second assembly hole 53 to which the rear cover 60 is assembled. The rear cover 60 may include the assembly portion 100 inserted in the first assembly hole 51 and the second assembly hole 53. The assembly portion 100 may include the hook 110 inserted in the first assembly hole 51. The assembly portion 100 may include the retainer 120 inserted in the second assembly hole 53. Other than the configuration of the retainer 120, the remaining configurations may be the same as the configuration shown in FIGS. 4 to 9. Of the configurations, the remaining configurations other than the configuration of a protrusion 125 may be the same as the configurations shown in FIGS. 4 to 9. Only the configuration of the protrusion 125, which is different from the configuration shown in FIGS. 4 to 9 will be described.

The retainer 120 may include a protrusion 125. The protrusion 125 may be formed to protrude from the retainer body 121. When the retainer 120 is inserted in the second assembly hole 53, the protrusion 125 may be supported on one side of the second assembly hole 53. The retainer 120 may be configured to protrude farther than the hook body 111 by a length by which the protrusion 125 protrudes from the retainer body 121. Because the retainer body 121 and the hook body 111 are positioned on the same line in the horizontal direction of the rear cover 60, the retainer 120 may be provided to protrude from the hook body 111 by a length such that the protrusion 125 protrudes from the retainer body 121.

When the hook head 113 is inserted into the first assembly hole 51, the protrusion 125 may protrude from the retainer body 121 by an amount corresponding to a gap between the first assembly hole 51 and the hook body 111. Since the protrusion 125 protrudes from the retainer body 121 by the gap between the first assembly hole 51 and the hook body 111 when the hook head 113 is inserted in the first assembly hole 51, the protrusion 125 may be supported on one side of the second assembly hole 53 when the hook head 113 is inserted in the first assembly hole 51.

The protrusion 125 may be provided as a protruding rib divided into a plurality of protruding ribs from the retainer body 121 and protruding therefrom. Although the plurality of protruding ribs 125 is shown as being divided in the horizontal direction, the present disclosure is not limited thereto. For example, the plurality of protruding ribs 125 may be provided to be divided in the vertical direction.

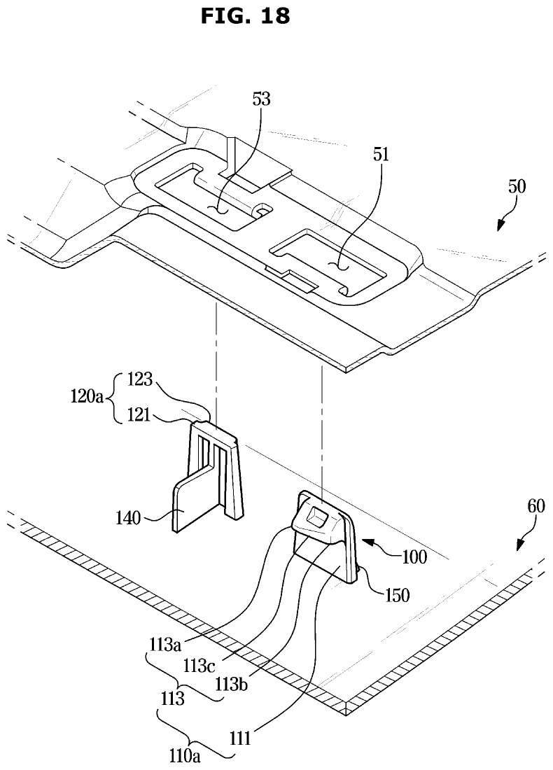

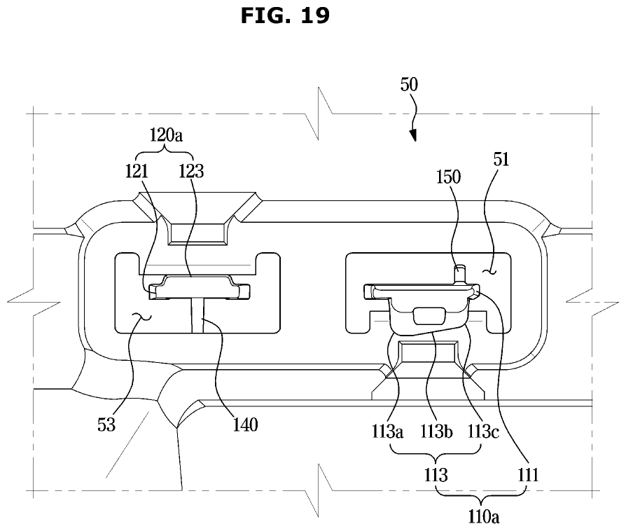

FIG. 18 is a view illustrating a state in which a hook and a retainer formed on a rear cover are provided separately, according to an embodiment. FIG. 19 is a view illustrating a state in which the assembly portion shown in FIG. 18 is inserted in a first assembly hole and a second assembly hole of a rear chassis, viewed from a front surface of the rear chassis.

As shown in FIGS. 18 and 19, the rear chassis 50 may include the first assembly hole 51 and the second assembly hole 53 to which the rear cover 60 is assembled. The rear cover 60 may include the assembly portion 100 inserted in the first assembly hole 51 and the second assembly hole 53. The assembly portion 100 may include a hook 110a inserted in the first assembly hole 51. The assembly portion 100 may include a retainer 120a inserted in the second assembly hole 53.

The hook 110a and the retainer 120a may be configured to be separable. That is, the hook 110a and the retainer 120a may be separate components that are not directly connected to each other. Because the hook 110a and the retainer 120a are provided to be separated, the assembly portion 100 may not include a connection rib connecting the hook 110a and the retainer 120a. Other than configurations in which the assembly portion 100 does not include a connection rib connecting the hook 110a and the retainer 120a, the remaining configurations may be the same as the configurations shown in FIGS. 4 to 9, so further description will be omitted.

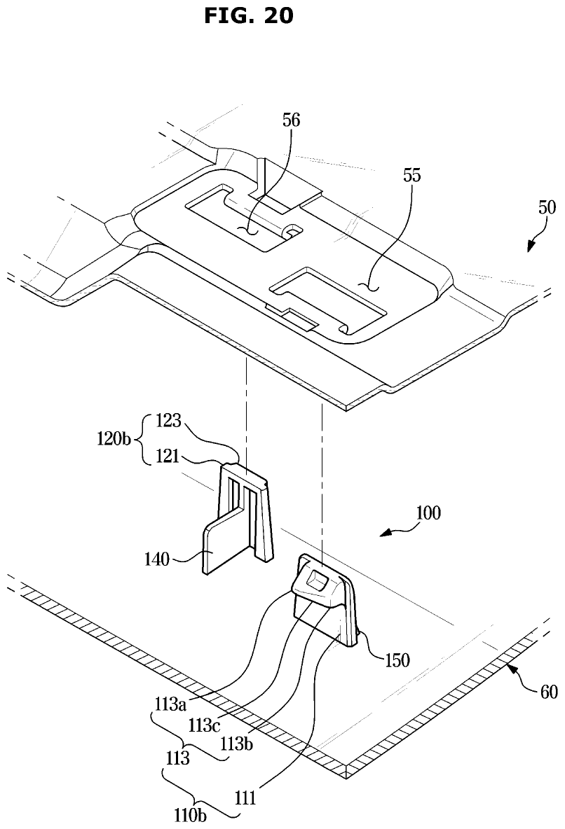

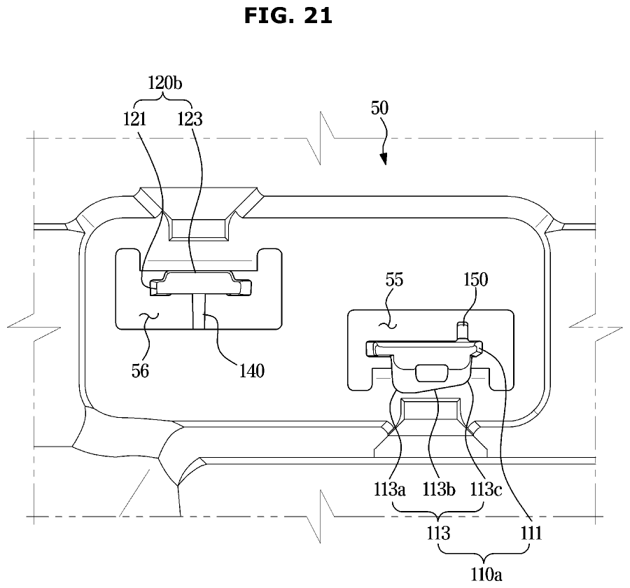

FIG. 20 is a view illustrating a state in which a hook and a retainer formed on a rear cover are provided to be offset from the same line in a horizontal direction of the rear cover according to an embodiment. FIG. 21 is a view illustrating a state in which the assembly portion shown in FIG. 20 is inserted in a first assembly hole and a second assembly hole of a rear chassis, viewed from a front surface of the rear chassis.

As shown in FIGS. 20 and 21, the rear chassis 50 may include a first assembly hole 55 and a second assembly hole 56 to which the rear cover 60 is assembled. The rear cover 60 may include the assembly portion 100 inserted in the first assembly hole 55 and the second assembly hole 56. The assembly portion 100 may include a hook 110b inserted in the first assembly hole 55. The assembly portion 100 may include a retainer 120b inserted in the second assembly hole 56.

The hook 110b and the retainer 120b may be provided to be offset from the same line in the horizontal direction of the rear cover 60. The hook 110b and the retainer 120b may not be positioned on the same line in the horizontal direction of the rear cover 60. The first assembly hole 55 and the second assembly hole 56 formed in the rear chassis 50 may be formed to correspond to positions of the hook 110b and the retainer 120b.

The hook 110b and the retainer 120b may be provided to be separable. Because the hook 110b and the retainer 120b are provided to be separated, the assembly portion 100 may not include a connection rib connecting the hook 110b and the retainer 120b.

Other than configurations in which the hook 110b and the retainer 120b are not positioned on the same line (e.g., are offset) in the horizontal direction of the rear cover 60, the first assembly hole 55 and the second assembly hole 56 are not positioned on the same line in the horizontal direction of the rear chassis 50 so as to correspond to the positions of the hook 110b and the retainer 120b, and the assembly portion 100 does not include a connection rib connecting the hook 110b and the retainer 120b, the remaining configurations may be the same as the configurations shown in FIGS. 4 to 9, so further description will be omitted.

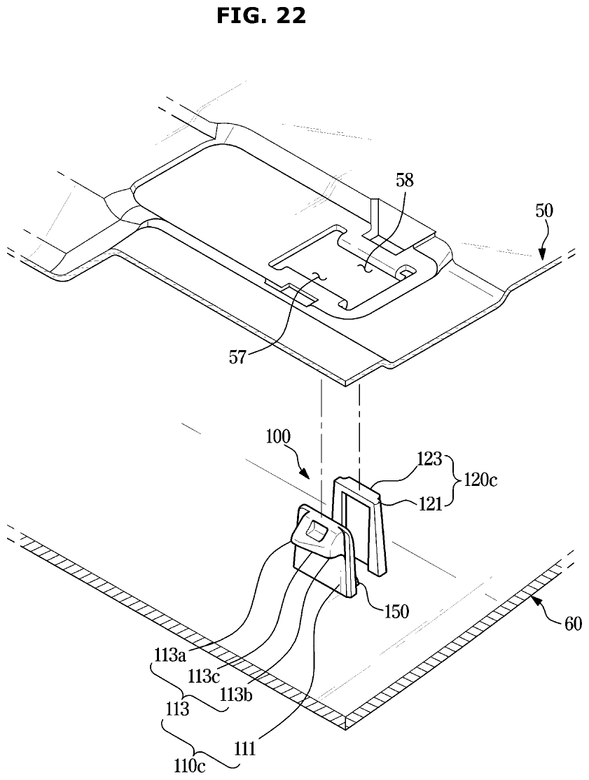

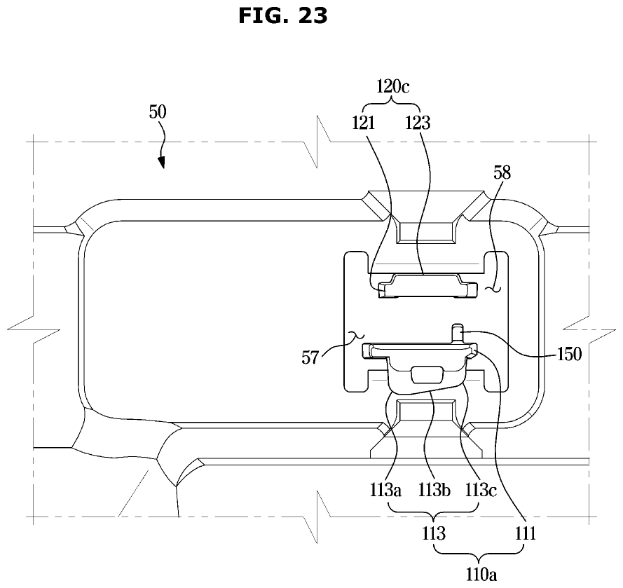

FIG. 22 is a view illustrating a state in which a hook and a retainer formed on a rear cover are provided on the same line in a vertical direction of the rear cover according to an embodiment. FIG. 23 is a view illustrating a state in which the assembly portion shown in FIG. 22 is inserted in a first assembly hole and a second assembly hole of a rear chassis, viewed from a front surface of the rear chassis.

As shown in FIGS. 22 and 23, the rear chassis 50 may include a first assembly hole 57 and a second assembly hole 58 to which the rear cover 60 is assembled. The rear cover 60 may include the assembly portion 100 inserted in the first assembly hole 57 and the second assembly hole 58. The assembly portion 100 may include a hook 110c inserted in the first assembly hole 57. The assembly portion 100 may include a retainer 120c inserted in the second assembly hole 58.

The hook 110c and the retainer 120c may be provided to be positioned on the same line in the vertical direction of the rear cover 60. The first assembly hole 57 and the second assembly hole 58 formed in the rear chassis 50 may be connected to each other in the vertical direction of the rear chassis 50 to form a single hole so as to correspond to the positions of the hook 110c and the retainer 120c. Because the hook 110c and the retainer 120c are provided to be positioned on the same line in the vertical direction of the rear cover 60, the retainer 120c may not include an anti-separation rib.

The hook 110c and the retainer 120c may be provided to be separable. Because the hook 110c and the retainer 120c are provided to be separated, the assembly portion 100 may not include a connection rib connecting the hook 110c and the retainer 120c.

Other than configurations in which the hook 110c and the retainer 120c are positioned on the same line in the vertical direction of the rear cover 60, the first assembly hole 57 and the second assembly hole 58 are connected in the vertical direction of the rear chassis 50 to form a single hole, the assembly portion 100 does not include an anti-separation rib extending from the retainer 120c, and the assembly portion 100 does not include a connection rib connecting the hook 110c and the retainer 120c, the remaining configurations may be the same as the configurations shown in FIGS. 4 to 9, so further description will be omitted.

The display apparatus according to an embodiment of the present disclosure may include the display panel 10, the rear chassis 50 disposed on a rear side of the display panel and including the first assembly hole 51, 55 or 57 and the second assembly hole 53, 56 or 58, and the rear cover 60 assembled in a rear surface of the rear chassis and including the assembly portion 100 inserted in the first assembly hole and the second assembly hole. The assembly portion may include the hook 110, 110a, 110b or 110c inserted in the first assembly hole, and the retainer 120, 120a, 120b or 120c provided adjacent to the hook, inserted in the second assembly hole, and configured to transmit a force, generated by movement of the rear cover when the rear cover is inserted in the rear chassis, to the hook.

The assembly portion may include the connection rib 130 connecting the hook and the retainer such that they are positioned on the same line in a horizontal direction of the rear cover, the anti-separation rib 140 extending perpendicularly from the retainer along a front surface of the rear cover, and the reinforcing rib 150 provided on the hook to increase strength of the hook.

The hook may include the hook body 111 connected to the connection rib such that the hook body and the connection rib are positioned on the same line in the horizontal direction of the rear cover, the hook body on which the reinforcing rib is formed, and the hook head 113, 115 or 117 formed to protrude from an upper portion of the hook body in a direction in which the anti-separation rib extends, the hook body being inserted in the first assembly hole.

The hook head may include the first portion 113a adjacent to the retainer, the second portion 113b formed on an opposite side of the first portion and protruding from the hook body by a distance that is shorter than a protrusion distance of the first portion, and the inclined surface 113c connecting the first portion and the second portion in an inclined manner.

The hook head may include the first portion 115a adjacent to the retainer, the second portion 115b formed on an opposite side of the first portion and protruding from the hook body by a distance that is longer than the protrusion distance of the first portion, and the inclined surface 117b connecting the first portion and the second portion in an inclined manner.

The hook head may include the first portion 117a adjacent to the retainer, the second portion 117b formed on an opposite side of the first portion and protruding from the hook body at a same distance as a protruding distance of the first portion, and the connection surface 117c connecting the first portion and the second portion.

The retainer may include the retainer body 121 or 122 connected to the connection rib such that the retainer body and the connection rib are positioned on the same line in the horizontal direction of the rear cover, and the protrusion 123 or 125 protruding from the retainer body to be supported by the second assembly hole.

The retainer may be configured to protrude farther than the hook body by a length by which the protrusion protrudes from the retainer body.

The protrusion may be provided as the integral protrusion 123 protruding integrally from the retainer body.

The protrusion may be provided as the protruding rib 125 divided into a plurality from the retainer body and protruding therefrom.

The hook 110a and the retainer 120a may be provided separately.

The assembly portion may include the anti-separation rib 140 extending perpendicularly from the retainer along a front surface of the rear cover, and the reinforcing rib 150 provided on the hook to increase strength of the hook.

The hook and the retainer may be configured to be positioned on the same line in the horizontal direction of the rear cover.

The hook 110b and the retainer 120b may be configured to be offset from the same line in the horizontal direction of the rear cover.

The hook 110c and the retainer 120c may be configured to be positioned on the same line in a vertical direction of the rear cover.

The display apparatus according to an embodiment of the present disclosure may include a display panel, a rear chassis disposed on a rear side of the display panel and including a first assembly hole and a second assembly hole, and a rear cover assembled to a rear surface of the rear chassis and including an assembly portion inserted in the first assembly hole and the second assembly hole. The assembly portion may include a hook inserted in the first assembly hole, and a retainer provided adjacent to the hook, inserted in the second assembly hole, and configured to guide a position of the hook such that the position of the hook corresponds to a position of the first assembly hole when the hook is inserted in the first assembly hole.

The hook may include a hook body connected to the retainer such that the hook body and the retainer are positioned on the same line in a horizontal direction of the rear cover, and a hook head formed to protrude from an upper portion of the hook body and inserted in the first assembly hole.

The retainer may include a retainer body connected to the hook such that the retainer body and the hook are positioned on the same line in a horizontal direction of the rear cover, and a protrusion protruding from the retainer body to be supported by the second assembly hole.

The retainer body may be configured to have a higher height from the rear cover than the hook body.

The hook body and the retainer body may be configured to have the same height from the rear cover.

According to the present disclosure, the assembly portion formed on the rear cover may be directly inserted in the assembly hole formed in the rear chassis, thereby reducing costs by eliminating the use of screws, wires, or the like required for assembly.

According to the present disclosure, the rear cover may be disassembled from the rear chassis without the need for a separate tool, thereby improving the ability to disassemble the device.

According to the present disclosure, the gap between the rear cover and the rear chassis may be reduced, resulting in a slimmer design.

According to the present disclosure, the ease of assembling the rear cover to the rear chassis may be improved.

According to the present disclosure, damage to the hook inserted in the rear chassis may be prevented, and deviation of the hook from the assembly hole formed in the rear chassis may be prevented.

According to an aspect of an example embodiment, a display apparatus may include a display panel, a rear chassis on a rear side of the display panel and including a first assembly hole and a second assembly hole, and a rear cover on a rear surface of the rear chassis and including an assembly portion in the first assembly hole and the second assembly hole, where the assembly portion includes a hook in the first assembly hole and a retainer adjacent to the hook, in the second assembly hole, and configured to transmit, to the hook, a force generated by movement of the rear cover in response to the rear cover being assembled to the rear chassis.

The assembly portion may include a connection rib connecting the hook and the retainer such that the hook and the retainer are aligned in a first direction, an anti-separation rib extending in a second direction perpendicular to the first direction and extending from the retainer along a front surface of the rear cover, and a reinforcing rib on the hook and configured to increase strength of the hook.

The hook may include a hook body connected to the connection rib such that the hook body and the connection rib are aligned in the first direction, where the reinforcing rib is on the hook body, and a hook head protruding from an upper portion of the hook body in the second direction, the hook head being in the first assembly hole.

The hook head may include a first portion adjacent to the retainer and protruding from the hook body by a first length, a second portion spaced apart from the first portion and protruding from the hook body by a second length that is shorter than the first length, and an inclined surface connecting the first portion and the second portion.

The hook head may include a first portion adjacent to the retainer and protruding from the hook body by a first length, a second portion spaced apart from the first portion and protruding from the hook body by a second length that is longer than the first length, and an inclined surface connecting the first portion and the second portion.

The hook head may include a first portion adjacent to the retainer and protruding from the hook body by a first length, a second portion spaced apart from the first portion and protruding from the hook body by a second length that is the same as the first length, and a connection surface connecting the first portion and the second portion.

The retainer may include a retainer body connected to the connection rib such that the retainer body and the connection rib are aligned in the first direction and a protrusion protruding from the retainer body and configured to be supported by the second assembly hole.

The retainer may be configured to protrude relative to the hook body by a length by which the protrusion protrudes from the retainer body.

The protrusion may be integral with the retainer body.

The protrusion may include a plurality of protruding ribs that are spaced apart from each other and protruding from the retainer body.

The hook and the retainer may be separate components.

The assembly portion may include an anti-separation rib extending in a first direction from the retainer along a front surface of the rear cover and a reinforcing rib on the hook and configured to increase strength of the hook.

The hook and the retainer may be aligned in a second direction that is perpendicular to the first direction.

The hook and the retainer may be offset in a second direction that is perpendicular to the first direction.

The hook and the retainer may be aligned in vertical direction with respect to the rear cover.

According to an aspect of an example embodiment, a display apparatus may include a display panel, a rear chassis on the display panel and including a first assembly hole and a second assembly hole, and a rear cover including an assembly portion, where the assembly portion includes a hook configured to be inserted in the first assembly hole, and a retainer adjacent to the hook, configured to be inserted in the second assembly hole, and configured to transmit, to the hook, a force generated by movement of the rear cover in response to the rear cover being assembled to the rear chassis.

The assembly portion may include a connection rib connecting the hook and the retainer such that the hook and the retainer are aligned in a first direction, an anti-separation rib extending in a second direction perpendicular to the first direction and extending from the retainer along a front surface of the rear cover, and a reinforcing rib on the hook and configured to increase strength of the hook.

The hook may include a hook body connected to the connection rib such that the hook body and the connection rib are aligned in the first direction, where the reinforcing rib is on the hook body, and a hook head protruding from an upper portion of the hook body in the second direction, the hook head being configured to be inserted in the first assembly hole.

According to an aspect of an example embodiment, an assembly portion may include a hook configured to be inserted in a first assembly hole of a chassis that is on a display panel, and a retainer adjacent to the hook and configured to be inserted in a second assembly hole of the chassis that is adjacent to the first assembly hole, and transmit, to the hook, a force generated by movement of a cover in response to the cover being assembled to the chassis.

The assembly portion may include a connection rib connecting the hook and the retainer, an anti-separation rib extending perpendicularly from the retainer and a reinforcing rib on the hook and configured to increase strength of the hook.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A display apparatus, comprising:
a display panel;
a rear chassis on a rear side of the display panel and comprising a first assembly hole and a second assembly hole; and
a rear cover on a rear surface of the rear chassis and comprising an assembly portion in the first assembly hole and the second assembly hole,
wherein the assembly portion comprises:
a hook in the first assembly hole; and
a retainer adjacent to the hook, in the second assembly hole, and configured to transmit, to the hook, a force generated by movement of the rear cover in response to the rear cover being assembled to the rear chassis.

2. The display apparatus of claim 1, wherein the assembly portion further comprises:
a connection rib connecting the hook and the retainer such that the hook and the retainer are aligned in a first direction;
an anti-separation rib extending in a second direction perpendicular to the first direction and extending from the retainer along a front surface of the rear cover; and
a reinforcing rib on the hook and configured to increase strength of the hook.

3. The display apparatus of claim 2, wherein the hook comprises:
a hook body connected to the connection rib such that the hook body and the connection rib are aligned in the first direction, wherein the reinforcing rib is on the hook body; and
a hook head protruding from an upper portion of the hook body in the second direction, the hook head being in the first assembly hole.

4. The display apparatus of claim 3, wherein the hook head comprises:
a first portion adjacent to the retainer and protruding from the hook body by a first length;
a second portion spaced apart from the first portion and protruding from the hook body by a second length that is shorter than the first length; and
an inclined surface connecting the first portion and the second portion.

5. The display apparatus of claim 3, wherein the hook head comprises:
a first portion adjacent to the retainer and protruding from the hook body by a first length;
a second portion spaced apart from the first portion and protruding from the hook body by a second length that is longer than the first length; and
an inclined surface connecting the first portion and the second portion.

6. The display apparatus of claim 3, wherein the hook head comprises:
a first portion adjacent to the retainer and protruding from the hook body by a first length;
a second portion spaced apart from the first portion and protruding from the hook body by a second length that is the same as the first length; and
a connection surface connecting the first portion and the second portion.

7. The display apparatus of claim 3, wherein the retainer comprises:
a retainer body connected to the connection rib such that the retainer body and the connection rib are aligned in the first direction; and
a protrusion protruding from the retainer body and configured to be supported by the second assembly hole.

8. The display apparatus of claim 7, wherein the retainer is configured to protrude relative to the hook body by a length by which the protrusion protrudes from the retainer body.

9. The display apparatus of claim 8, wherein the protrusion is integral with the retainer body.

10. The display apparatus of claim 8, wherein the protrusion comprises a plurality of protruding ribs that are spaced apart from each other and protruding from the retainer body.

11. The display apparatus of claim 1, wherein the hook and the retainer are separate components.

12. The display apparatus of claim 11, wherein the assembly portion further comprises:
an anti-separation rib extending in a first direction from the retainer along a front surface of the rear cover; and
a reinforcing rib on the hook and configured to increase strength of the hook.

13. The display apparatus of claim 12, wherein the hook and the retainer are aligned in a second direction that is perpendicular to the first direction.

14. The display apparatus of claim 12, wherein the hook and the retainer are offset in a second direction that is perpendicular to the first direction.

15. The display apparatus of claim 1, wherein the hook and the retainer are aligned in vertical direction with respect to the rear cover.

16. A display apparatus, comprising:
a display panel;
a rear chassis on the display panel and comprising a first assembly hole and a second assembly hole; and
a rear cover comprising an assembly portion,
wherein the assembly portion comprises:
a hook configured to be inserted in the first assembly hole; and
a retainer adjacent to the hook, configured to be inserted in the second assembly hole, and configured to transmit, to the hook, a force generated by movement of the rear cover in response to the rear cover being assembled to the rear chassis.

17. The display apparatus of claim 16, wherein the assembly portion further comprises:
a connection rib connecting the hook and the retainer such that the hook and the retainer are aligned in a first direction;
an anti-separation rib extending in a second direction perpendicular to the first direction and extending from the retainer along a front surface of the rear cover; and
a reinforcing rib on the hook and configured to increase strength of the hook.

18. The display apparatus of claim 17, wherein the hook comprises:
a hook body connected to the connection rib such that the hook body and the connection rib are aligned in the first direction, wherein the reinforcing rib is on the hook body; and
a hook head protruding from an upper portion of the hook body in the second direction, the hook head being configured to be inserted in the first assembly hole.

19. An assembly portion, comprising:
a hook configured to be inserted in a first assembly hole of a chassis that is on a display panel; and
a retainer adjacent to the hook and configured to:
be inserted in a second assembly hole of the chassis that is adjacent to the first assembly hole, and
transmit, to the hook, a force generated by movement of a cover in response to the cover being assembled to the chassis.

20. The assembly portion of claim 19, further comprising:
a connection rib connecting the hook and the retainer;
an anti-separation rib extending perpendicularly from the retainer; and
a reinforcing rib on the hook and configured to increase strength of the hook.
